(19) United States
(12) Patent Application Publication
(10) Pub. No.: US 2013/0288051 A1
(43) Pub. Date: Oct. 31, 2013

(54) MECHANICAL AND ANTICORROSIVE PROTECTION VINYL TAPE

(71) Applicants: Vanessa Correa Arantes, Sao Paulo (BR); Mitsuo M. Yamasihita, Sao Paulo (BR)

(72) Inventors: Vanessa Correa Arantes, Sao Paulo (BR); Mitsuo M. Yamasihita, Sao Paulo (BR)

(73) Assignee: 3M INNOVATIVE PROPERTIES COMPANY, St. Paul, MN (US)

(21) Appl. No.: 13/996,646

(22) PCT Filed: Dec. 22, 2011
(86) PCT No.: PCT/US2011/066860

§ 371 Date: Jun. 21, 2013

(30) Foreign Application Priority Data
Dec. 30, 2010 (BR) PIU 1005582-7

(51) Int. Cl. C09J 7/02

(52) U.S. Cl. CPC C09J 7/0214
USPC 428/355 BL; 524/296

(57) ABSTRACT

Pressure sensitive tape for anticorrosion steel pipe protection used primarily in cases of repair and maintenance, comprising vinyl base-tape laminated with a nitrile rubber-based adhesive of the following composition: about 30.7 to about 34.0% (w/w) solid butadiene acrylonitrile rubber (NBR); about 0.57 to about 0.63% (w/w) antioxidant; about 9.7 to about 12.9% (w/w) hydrocarbon resin; about 1.52 to about 1.68% (w/w) zinc oxide; about 8.7 to about 9.5% (w/w) liquid butadiene acrylonitrile rubber. (NBR); about 4.0 to about 4.4% (w/w) aluminium hydrosilicate; about 5.5 to about 7.5% (w/w) diisononyl phthalate; about 0.66 to about 0.74% (w/w) carbon black; about 1.5 to about 1.7% (w/w) amorphous silica; and about 25.8 to about 38.8% (w/w) magnesium and calcium carbonate. The tape exhibits a good ability to conform to irregular surfaces, good elasticity, good impact resistance, excellent pipe adhesion and good cathodic detachment. The tape is ideally used in conjunction with a primer that improves adhesion between the pipe and the adhesive portion of the tape.

### TECHNICAL FIELD

The present application concerns the field of tapes developed for protecting pipelines (which transports gas or liquid) against atmosphere and soil aggression, including maintaining and repairing the pipes.

### BACKGROUND

The products commercially available in the market typically have the following characteristics:
Asphaltic base—primer;
Black polyethylene tape laminated with asphaltic base adhesive; and
White polyethylene tape used for mechanically protecting the system.

Other commercially available products do not meet the market requirements and do not provide the required high level of adhesion; therefore, they could not be used in this application. Those products are used for applications that do not require high mechanical strength and in cases where the pipe has already been covered with an anticorrosion coating. The present invention provides higher levels of adhesion, moisture and chemical and mechanical strength and a good cathodic detachment.

Most documents from the state of the art relate to the use of tapes or other products for pipe protection which are comprised of bitumen-based feedstock. Some documents claim both a polyethylene tape and cross-linked systems; however, none of them utilizes a PVC base similar to the invention and which comprises the same characteristics.

Patent HUT057247 describes a bitumen-based anticorrosive and insulating system which is comprised of three layers, namely, a base layer, an intermediate layer and a light reflection layer. The composition consists of a mixture of 15-35 parts by weight of bitumen in the range of 80-100° C. softening, 3-8 parts by weight of bitumen having a softening point higher than 100° C., 0.1-1.5 weight parts of styrene-butadiene-styrene copolymer, 1.8-4.8 weight parts of varnish flax seed oil, 1.2-3.2 weight parts of modified resin, 20-60 weight parts of nonpolar hydrocarbon solvent, 6-26 weight parts of chalk powder, 1-3 weight parts of silica gel or zeolite, 6-12 weight parts of asbestos or polypropylene fiber, 15-27 weight-parts of aluminum paste, 0.1-1.5 weight parts of cobalt naphthenate or copper.

Patent RU2325585 describes a method intended for protection against corrosion of manifold, field and process pipelines that transport gas or liquid. The method includes cleaning of external pipeline surface from old coating and rust, applying a layer of primer on pipeline external surface, spiral winding of insulating anticorrosive material with overlapping on layer of primer and spiral winding with overlapping of wrapping external layer of polymer tape on layer of insulating anticorrosive material. The primer is applied on dry surface of pipeline, spiral winding of insulating anticorrosive material is done on wet primer by machine method from three bobbins. The insulating anticorrosive material is a layer of bitumen-polymer mastic compound, which has reinforcing glass mesh in it, and spiral winding of tape is done with overlapping. The external wrapping layer is a tape, which constitutes coiled material that is produced by applying mastic compound melt on polyethylene tape based on thermo-light-stabilized polyethylene or heat-shrinkage tape. Effect: it increases reliability and working life of pipeline.

Patent UA 75225 refers to polymeric anticorrosive tape that consists of a protective radiation cross-linked polyethylene layer and sticky adhesive layer on the basis of Acrylonitrile, synthetic resin, commercial carbon, oil asphalt, oxide of metal, mineral filler, heat stabilizer. The composition of protective polymeric layer includes titanium dioxide and sensitizer, and the composition of sticky adhesive layer additionally contains epoxy copolymer of ethylene and oligomeric natural rubber.

Patent RU2199051 describes a tape that has a base made from polymer material and mastic layer made from mixture of polymer ASMOL and bitumen at content of 30%. The adhesive layer is protected by means of anti-adhesive made from polyethylene terephthalate. Used as polymer base is thermally shrinkable tape.

Patent JP01017881 relates to a petrolatum-based anticorrosive composition, etc., containing tannic acid having ≧40 μm size, a plasticizer such as wax, and a filler such as silica and clay are mixed to obtain a pasty anticorrosive composition. The obtained composition is coated on both sides of a base material of a porous material such as nonwoven fabric and felt or the laminate of the porous material and the film of PE, PP, PVC, etc., having low permeability to gas to obtain an anticorrosive sheet or tape. The porous protecting sheet consisting of (non)woven fabric or rayon, acrylic fiber, polyester fiber, etc., having 5W50% porosity, having 1W3,000 μm thickness, and having the size identical to or larger than the sheet or tape is laminated on one or both sides of the sheet or tape.

Patent WO9516160 describes a method of providing corrosion protection to a joint area in a weight coated marine pipe line and a tape suitable for use in that method. The pipe line comprises a plurality of pipes (2) each with an anti-corrosion coat (4) and a weight coat (6) applied over the anti-corrosion coat (4). The method comprises (a) applying as a circumferential wrap: (i) a first tape member comprising a flexible heat resistant waterproofing backing film (22) such as a high temperature PVC film and a pressure sensitive adhesive layer (28) having a width spanning and adhered to a first joint length of exposed pipe (2a) on either side of a welded joint (4b) and at least partially overlying and adhered to a second joint length adjacent to the first joint length on either side of the joint covered by the anti-corrosion coat, but not the weight coat; and (ii) a second tape member (24) comprising a high melting point abrasion resistant film such as a polyester film having a width less than the width of the first tape member (22) and being laminated at the centre of the outer surface of the first tape so as when applied to overlie the first joint length of exposed pipe (2a) and not to overlie the second joint length (4b), and (b) filling the joint volume (10). The first and second tape members are conveniently provided in the form of a prelaminated tape with the pressure-sensitive adhesive layer (28) protected by a release film or paper (30).

Patent RU2319891 describes the production of materials used for corrosion protection of pipes and pining systems; protection of external steel pipe lines carrying natural gas, oil and petroleum products against underground and atmospheric corrosion. Substance: proposed mastic contain bitumen 40/180 (or 45/190), polymer and plasticizing agent; used as polymer is styrene-butadiene thermoelastic elastomer; used as plasticizing agent is oil −6 at the following concentration of components, mass-%: bitumen, 77-99; polymer, 0.5-15; plasticizing agent, 0.5-8. Proposed bitumen polymer mastic is applied on polymer base in molten state by mechanized method; cross-linked polyethylene base or PVC tape may be used as base. Coiled material thus obtained is used as wrapping for insulation of pipes. Effect: enhanced corrosion protection of pipes due to enhanced adhesion of mastic to steel and to base; enhanced freeze resistance.

Patent KR20020072818 describes a corrosion proofing structure of a steel pipe pile is provided to keep a structure semi-permanently by preventing corrosion. The corrosion proofing structure of a steel pipe pile comprises: a petrolatum tape (12) covered over an inter-tidal zone and a splash zone of a steel pipe pile (10) kept cleanly by a high-pressure water jetting pump using seawater; a PVC (Polyvinyl Chloride) sheet (14) covered on the petrolatum tape (12); an H.D.P.E(High Density Polyethylene) cover (20) installed closely to the covering part of the PVC sheet (14) and fixed by a fastener; a streamlined cover protecting piece (30) installed to the outside of the H.D.P.E cover (20); underwater hardening epoxy resins (35) caulked thinly on a joint between the H.D.P.E cover (20) and concrete; and a steel band (40) containing a flange and a bearing steel plate.

### SUMMARY

The present invention relates to a tape for anticorrosion and mechanical steel pipe protection used primarily in cases of repair and maintenance, comprising this vinyl base—tape laminated with a nitrile rubber-based adhesive. The tape of the present invention comprises an adhesive portion and a non-adhesive portion.

The tape has been designed to be applied in combination with a commercially available anticorrosive coating, which, in this case, acts as a primer. Because of the compatibility between the tape and the primer, the adhesion therebetween and on the vinyl strengthening is very high. The tape can be used for mechanical and anticorrosive protection of windpipes and underground pipes.

At least one embodiment of the material of the present invention exhibits a good ability to conform to irregular surfaces, good elasticity, good impact resistance, excellent pipe adhesion and good cathodic detachment.

At least one embodiment of the product of the present invention is a vinyl tape coated with PSA rubber adhesive.

The summary of the present invention, as provided above, is not intended to describe each of the illustrated embodiments or all implementation of the present invention. The figures and detailed description hereinbelow exemplify more particularly those embodiments.

### BRIEF DESCRIPTION OF THE DRAWINGS

The present invention will be further described with reference to the appended drawings, where:

FIG. 1 illustrates a typical pipeline whereto the present invention is usually applied;

FIG. 2 illustrates a typical pipeline whereto the primer/coating has been applied;

FIG. 3 shows a typical illustration of a pipeline whereto the adhesive tape has been applied.

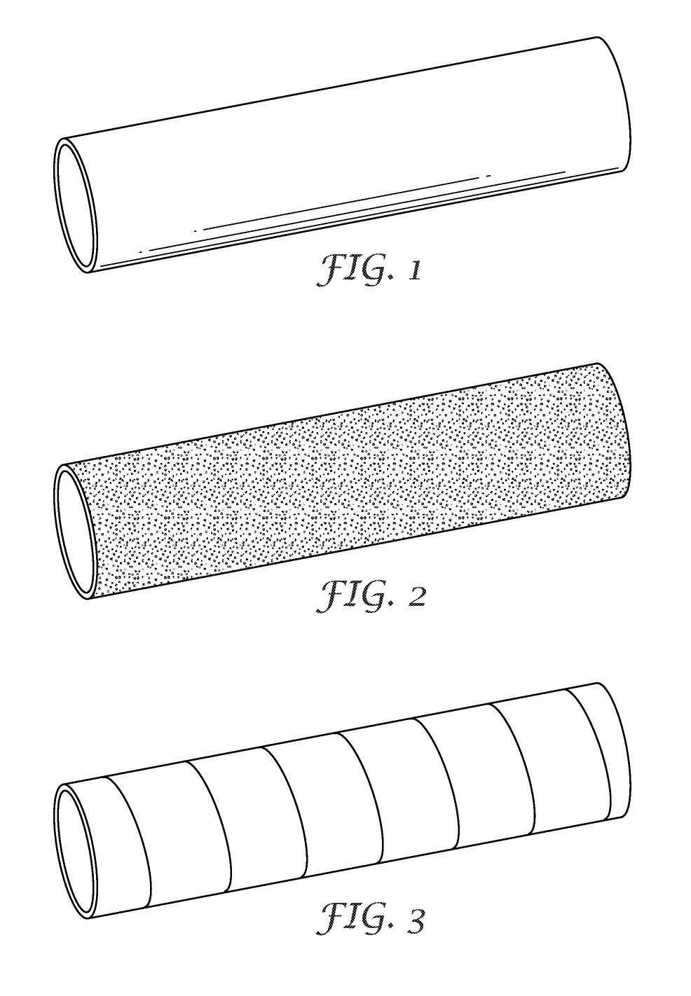

Although the invention is adaptable to various modifications and alternative forms, specificities thereof have been shown for the purposes of exemplification in the drawings, and they will be described in details. It should be understood, however, that there is no intention to limit the invention to the specific described embodiments. Rather, the intention is to include all modifications, equivalents and alternatives contained in the scope of the invention as defined by the appended claims.

### DETAILED DESCRIPTION

In the following detailed description of the preferred embodiments, a reference is made to the appended drawings, which illustrate specific accomplishments in which the invention may be practiced. The embodiments illustrated herein are not intended to be accomplished by all embodiments in accordance with the invention. It should be understood that other embodiments may be utilized and that structural or logic changes may be made without departing from the scope of the present invention. Therefore, the description detailed hereinbelow should not be construed as a limiting characteristic, and the scope of the present invention is defined by the appended claims.

The present description refers to a anticorrosive protection vinyl tape comprising an adhesive portion and a non-adhesive portion, in which the adhesive portion comprises:

from about 30.7 to about 34.0% by weight of solid butadiene acrylonitrile rubber (NBR);

of about 0.57 to about 0.63% by weight of antioxidant;

from about 9.7 to about 12.9% by weight of hydrocarbon resin;

from about 1.52 to about 1.68% by weight of zinc oxide;

from about 8.7 to about 9.5% by weight of liquid butadiene acrylonitrile rubber (NBR);

from about 4.0 to about 4.4% by weight of aluminum hydrosilicate;

from about 5.5 to about 7.5% by weight of diisononyl phthalate;

from about 0.66 to about 0.74% by weight of carbon black;

from about 1.5 to about 1.7% by weight of amorphous silica; and

from about 25.8 to about 38.8% by weight of magnesium and calcium carbonate.

Preferably, the adhesive tape portion comprises 32.3% by weight of solid butadiene acrylonitrile rubber (NBR), 0.6% by weight of antioxidant, 11.3% by weight of hydrocarbon resin, 1.6% by weight of zinc oxide, 9.1% by weight of liquid butadiene acrylonitrile rubber (NBR), 4.2% by weight of aluminum hydrosilicate, 6.5% by weight of diisononyl phthalate, 0.7% by weight of carbon black, 1.6% by weight of amorphous silica and 32.1% by weight of magnesium and calcium carbonate, based on the total weight of the composition.

The non-adhesive portion comprises a vinyl base in form of film formulation which is commonly found in the state of the art, preferably having thickness between 0.20 to 0.40 mm, further more preferably from 0.25 to 0.35 mm.

The main product function of the present invention is to increase the pipeline durability, by protecting it against oxidation produced by the underground and time aggression and by avoiding repairs and emptying. The coating is applied over the pipe, and then the tape is involved, promoting the tube protection.

The tape is fast and easily applicable in the field, because it eliminates any way of heating, therefore not being necessary neither the mixing thereof with different components nor undergoing the healing process.

Due to the compatibility between the primer, the adhesive and the vinyl film, the system provides excellent adhesion, assuring thereby a higher protection of the tube.

The primer and the tape have a very low stickiness when touched by the hands. In practice, this is very important because there may be product contamination due to dust and dirt in the field. Therefore, after the tape is applied over the primer, there is a high chemical interaction therebetween and after a few minutes the adhesion is initiated.

The first step is to properly prepare the pipe surface. Preferably, the surface should be cleaned with a suitable solvent and then through sand blasting, steel grit, sanding, brushing or even other forms of surface preparation.

The second step is to apply the primer by using a brush or paint roller and wait for drying, which usually occurs between 5 to 10 minutes depending on the heat and humidity weather conditions.

The third is the application of a PVC tape, preferably with a minimum overlap of 50% involving the tube.

### EXAMPLES

The objects and advantages of this invention are further illustrated by the following examples; however, the particular materials and amounts reported in these examples, as well as other conditions and details, should not be construed to unduly limit this invention.

### List of Used Materials:

Adhesive composition (tape adhesive)—The main factor of this invention is the adhesive that promotes a high adhesion/compatibility between the PVC film and the anticorrosive primer.

| | | | Weight in the | |
|---|---|---|---|---|
| | Trade | | Composition | Weight |
| Material | Name | Supplier | (%) | Range (%) |
| Butadiene Acrylonitrile | NBR 3350 | Petroflex | 32.3 | 30.7-34.0 |
| Rubber (NBR) | | | | |
| Antioxidant | Wingstay | Goodyear | 0.6 | 0.57-0.63 |
| Hydrocarbon resin | Unilene A | Petroquimica União | 11.3 | 9.7-12.9 |
| | 80 | (Union Petrochemical) | | |
| | | (PQU) | | |
| Zinc oxide | Zinc oxide | Votorantim Metais | 1.6 | 1.52-1.68 |
| Liquid Butadiene | Nipol 1312 | Zeon | 9.1 | 8.7-9.5 |
| Acrylonitrile | | | | |
| Rubber (NBR) | | | | |
| Aluminum hydrosilicate | SACA C5 | Itatex | 4.2 | 4.0-4.4 |
| | | Especialidades | | |
| | | Minerals | | |
| Diisononyl phthalate | DINP | Exxon | 6.5 | 5.5-7.5 |
| Carbon black | Carbon | Columbian Chemicals | 0.7 | 0.66-0.74 |
| | black | | | |
| Amorphous Silica | Ultrasil VN3 | Degussa | 1.6 | 1.5-1.7 |
| Calcium and | Dolomite | Brasilminas | 32.1 | 25.8-38.8 |
| Magnesium | | Indústria e | | |
| Carbonate | | Comércio | | |
| | | LTDA | | |

The adhesive tape is produced how the rubber formulations are usually processed.

In a first step, solid butadiene acrylonitrile rubber is crafted in roll mill, whereto anti-oxidant, hydrocarbon resin and zinc oxide are added; the rubber base obtained through this step is taken as slabs.

In a second step, the rubber base produced in the previous step is hot taken to a mixing equipment, which gradually grinds the rubber base and allows incorporating other substances that have been added throughout the process, such as hydrocarbon resin, silica, liquid butadiene acrylonitrile rubber, aluminum hydrosilicate, carbon black, calcium and magnesium carbonate, plasticizer. When all added substances restrictions have been homogeneously incorporated, a uniformly apparent mass is obtained.

In a third step, the adhesive tape obtained from the previous step is laminated to the vinyl film through either of two possibilities described below: in the first possibility, the adhesive mass undergoes a process of hot extrusion and is being directly deposited on the vinyl film at the extruder output, then being recovered by a protective paper, thus allowing the tape to be wrapped; in the second possibility, adhesive mass is processed in a set of calendar cylinders until it reaches the suitable thickness, and then it is laminated over vinyl film, subsequently being recovered by a protective paper, thus allowing the tape to be wrapped.

Table I below shows the typical properties for the anticorrosion coating, according to the standard rules.

TABLE I

| Property | | Test Method | Results |
|---|---|---|---|
| 2 | Solvent | — | Aliphatic |
| 3 | Solids (%) | ASTM D1644 | 25 |
| 4 | Viscosity (Meter Ford No. 4) (sec) | ASTM D1200 | 135 |
| 5 | Drying time (min) | ASTM D1640 | 15 |
| 6 | Application Temperature (° C.) | — | 10-50 |
| 7 | 25° C. Density (g/cm3) | ASTM D1475 | 0.88 |

The anticorrosive coating was evaluated for the cathodic detachment property through the test method described in ASTM G8, after a conditioning period of 28 days. The specification for this test is that detachment occurs up to 15 mm. The obtained results were on average 5 mm, meeting the concerned standard rules.

Table II shows the comparison between the commercially available tape and that of the present invention.

TABLE II

| | | | Commercially | |
|---|---|---|---|---|
| Properties | | Test Method | Available Tape | Invention |
| 1 | Color | Appearance | Black | Black |
| 2 | Film thickness (mm) | ASTM D1000 | 0.220 | 0.300 |
| 3 | Film adhesive (mm) | — | 0.030 | 0.700 |
| 4 | Total tape thickness (mm) | ASTM D1000 | 0.250 | 1.000 |
| 5 | Tensile strength (N/mm) | ASTM D1000 | 6.7 | 7.5 |
| 6 | Elongation (%) | ASTM D1000 | 302 | 322 |
| 7 | Insulation resistance (ohms) | ASTM D 257 | >1013 | >1013 |
| 8 | Tear strength - Longitudinal (N) | ASTM D1004 | 27.6 | 32.14 |
| 9 | Tear Resistance - Transversal (N) | ASTM D1004 | 26.3 | 32.58 |
| 10 | Impact Resistance (J) | ASTM G14 | 1.23 | 7.5 |
| 11 | Chemical Resistance: pH 4 to 10 | ASTM D543 | No attack | No attack |
| 12 | Fungi Growth Resistance | ASTM G21 | 30% growth | No growth |
| 13 | Adhesion to the primer after | ASTM D100 | 0.17 | 2.30 |
| | 24 hours (N/mm) | Method A) | | |
| 14 | Adhesion to strengthening after | ASTM D1000 | 0.30 | 2.35 |
| | 24 hours (N/mm) | | | |

The main difference between the products as shown in the table hereinabove concerns the adhesion and resistance to fungi growth.

The adhesion to the primer increases from 0.17 N/mm to 2.30 N/mm, and strengthening adhesion increases from 0.30 N/mm to 2.35 N/mm by using the adhesive as an adhesive.

Fungi Growth Resistance decreased from 30% to 0%. This means an increased durability of the tube.

Many obvious modifications of this product, as well as numerous structures to which the present invention may be applicable will be readily apparent to those skilled in the art after analysis of the present description, and therefore they are considered as encompassed within the scope of the invention.

1. Anticorrosive and mechanical protection vinyl tape, characterized in that the adhesive portion comprises:
from about 30.7 to about 34.0% by weight of solid butadiene acrylonitrile rubber (NBR);
of about 0.57 to about 0.63% by weight of antioxidant;
from about 9.7 to about 12.9% by weight of hydrocarbon resin;
from about 1.52 to about 1.68% by weight of zinc oxide;
from about 8.7 to about 9.5% by weight of liquid butadiene acrylonitrile rubber (NBR);
from about 4.0 to about 4.4% by weight of aluminum hydrosilicate;
from about 5.5 to about 7.5% by weight of diisononyl phthalate;
from about 0.66 to about 0.74% by weight of carbon black;
from about 1.5 to about 1.7% by weight of amorphous silica; and
from about 25.8 to about 38.8% by weight of calcium magnesium carbonate.

2. A tape according to claim 1, characterized in that the adhesive portion comprises, preferably, 32.3% by weight of solid butadiene acrylonitrile rubber (NBR), 0.6% by weight of antioxidant, 11.3% by weight of hydrocarbon resin, 1.6% by weight of zinc oxide, 9.1% by weight of liquid butadiene acrylonitrile rubber (NBR), 4.2% by weight of aluminum hydrosilicate, 6.5% by weight of diisononyl phthalate, 0.7% by weight of carbon black, 1.6% by weight of amorphous silica and 32.1% by weight of and calcium magnesium carbonate, based on the total weight of the composition.

3. (canceled)

4. Anticorrosive and mechanical protection vinyl tape, characterized in that it comprises the adhesive portion according to definition in claim 1 and the non-adhesive portion comprises a vinyl base having a thickness between 0.20 to 0.40 mm.
